(19) United States
(12) Patent Application Publication
(10) Pub. No.: US 2023/0075832 A1
(43) Pub. Date: Mar. 9, 2023

(54) ENERGY PRODICUTION DEVICE AND ASSOCIATED COMPONENTS, SYSTEMS, AND METHODS

(71) Applicant: Battelle Energy Alliance, LLC, Idaho Falls, ID (US)

(72) Inventors: Yasir Arafat, Idaho Falls, ID (US); Douglas C. Crawford, Idaho Falls, ID (US); Timothy A. Hyde, Idaho Falls, ID (US); Jess C. Gehin, Idaho Falls, ID (US); James W. Sterbentz, Idaho Falls, ID (US); Robert C. O'Brien, Idaho Falls, ID (US)

(21) Appl. No.: 17/759,332

(22) PCT Filed: Jan. 21, 2021
(86) PCT No.: PCT/US2021/014405

§ 371 Date: Jul. 22, 2022

Related U.S. Application Data
(60) Provisional application No. 62/964,517, filed on Jan. 22, 2020.

(51) Int. Cl. G21D 1/00; G21C 5/02; G21D 9/00; G21C 7/06

(52) U.S. Cl. CPC G21D 1/00; G21C 5/02; G21D 9/00; G21C 7/06

(57) ABSTRACT

An energy production device may include a core and a heat exchanger positioned over the core. The core may include one or more fuel rods. The core may further include a heat transmission fluid configured to flow through natural convection upwards through the one or more fuel rods and collect heat therefrom. The core may also include a reaction control device including a neutron-absorbing material. The heat exchanger may be configured to receive the heat transmission fluid and transfer the heat to an energy harnessing device positioned on an opposite side of the heat exchanger from the core.

### CROSS-REFERENCE TO RELATED APPLICATIONS

This application is a national phase entry under 35 U.S.C. § 371 of International Patent Application PCT/US2021/014405, filed Jan. 21, 2021, designating the United States of America and published as International Patent Publication WO 2021/150748 A2 on Jul. 29, 2021, which claims the benefit under Article 8 of the Patent Cooperation Treaty to U.S. Patent Application Ser. No. 62/964,517, filed Jan. 22, 2020.

### STATEMENT REGARDING FEDERALLY SPONSORED RESEARCH OR DEVELOPMENT

This invention was made with government support under Contract Number DE-AC07-05-ID14517 awarded by the United States Department of Energy. The government has certain rights in the invention.

### TECHNICAL FIELD

Embodiments of the present disclosure generally relate to energy production devices. In particular, embodiments of the present disclosure relate to nuclear energy production devices and associated components, systems, and methods.

### BACKGROUND

Some energy production devices harness heat by capturing, storing, or converting the heat to another form of energy, such as an electrical energy. The heat may be produced through burning processes, such as coal fire power plants, or by heat generated by a reactor, such as a nuclear reactor. Nuclear reactors contain and control nuclear chain reactions that produce heat through a physical process called fission, where a particle (e.g., a neutron) is fired at an atom, which then splits into two smaller atoms and some additional neutrons. Some of the released neutrons then collide with other atoms, causing them to also fission and release more neutrons. A nuclear reactor achieves criticality (commonly referred to in the art as going critical) when each fission event releases a sufficient number of neutrons to sustain an ongoing series of reactions. Fission also releases a large amount of heat. The heat is removed from the reactor by a circulating fluid. This heat can then be used to produce electricity or can be harnessed and stored for uses, such as heating a facility or heating water.

### BRIEF SUMMARY

Embodiments of the present disclosure may include an energy production device. The energy production device may include a core and a heat exchanger positioned over the core. The core may include one or more fuel rods. The core may further include a heat transmission fluid configured to flow through natural convection upwards through the one or more fuel rods and collect heat therefrom. The core may also include a reaction control device including a neutron-absorbing material. The heat exchanger may be configured to receive the heat transmission fluid and transfer the heat to an energy harnessing device positioned on an opposite side of the heat exchanger from the core.

Another embodiment of the present disclosure may include an energy production device. The energy production device may include a core. The core may include one or more fuel rods. The core may further include a heat transmission fluid configured to flow around the one or more fuel rods and collect heat therefrom. The core may also include a reaction control device including a neutron-absorbing material. The energy production device may further include a heat exchanger positioned over the core configured to receive the heat transmission fluid and transfer the heat to an intermediate fluid. The energy production device may also include an energy harnessing module removably coupled to the heat exchanger. The energy harnessing module may be configured to capture or convert heat energy from the intermediate fluid. The energy production device may further include a control system configured to control the reaction control device and energy harnessing module.

Another embodiment of the present disclosure may include a method of harnessing nuclear energy. The method may include controlling a nuclear fission reaction in a core including fuel rods. The method may further include causing a heat transmission fluid to flow upwards through the core using natural convection by heating the heat transmission fluid with the controlled nuclear fission reaction. The method may also include cooling the heat transmission fluid by transferring heat to an energy harnessing device through a heat exchanger positioned over the core. The method may further include harnessing the heat from the heat exchanger for storage, transmission, or conversion into another form of energy with the energy harnessing device. The method may also include flowing the heat transmission fluid through a downtube separate from the fuel rods after cooling the heat transmission fluid. The method may further include re-introducing the cooled heat transmission fluid below the fuel rods.

### BRIEF DESCRIPTION OF THE DRAWINGS

While the specification concludes with claims particularly pointing out and distinctly claiming embodiments of the present disclosure, the advantages of embodiments of the disclosure may be more readily ascertained from the following description of embodiments of the disclosure when read in conjunction with the accompanying drawings in which:

FIG. 1 illustrates a perspective view of an energy production device in accordance with embodiments of the present disclosure;

FIGS. 2 and 3 illustrate cross-sectional views of a core of the energy production device of FIG. 1 in accordance with embodiments of the present disclosure;

FIG. 4 illustrates an expanded view of a fuel element in accordance with embodiments of the present disclosure;

FIGS. 5 and 6 illustrate cross-sectional views of a core of the energy production device of FIG. 1 in accordance with embodiments of the present disclosure;

FIG. 7 illustrates a perspective view of components of the energy production device of FIG. 1 in accordance with embodiments of the present disclosure;

FIG. 8 illustrates an enlarged view of a reaction control device and control module of the energy production device of FIG. 1 in accordance with embodiments of the present disclosure;

FIG. 9 illustrates a sectional view of an energy harnessing device and heat exchanger of the energy production device of FIG. 1 in accordance with embodiments of the present disclosure;

FIG. 10 illustrates a visual representation of a mathematical model of heat transfer in the energy harnessing device and heat exchanger of FIG. 9 in accordance with embodiments of the present disclosure;

FIG. 11 illustrates a schematic view of a cooling system in accordance with embodiments of the present disclosure; and

FIG. 12 illustrates a schematic view of a containment area for the energy production device of FIG. 1 in accordance with embodiments of the present disclosure.

### DETAILED DESCRIPTION

The illustrations presented herein are not meant to be actual views of any particular energy production device or component thereof, but are merely idealized representations employed to describe illustrative embodiments. The drawings are not necessarily to scale.

As used herein, the term “substantially” in reference to a given parameter means and includes to a degree that one skilled in the art would understand that the given parameter, property, or condition is met with a small degree of variance, such as within acceptable manufacturing tolerances. For example, a parameter that is substantially met may be at least about 90% met, at least about 95% met, at least about 99% met, or even at least about 100% met.

As used herein, relational terms, such as “first,” “second,” “top,” “bottom,” etc., are generally used for clarity and convenience in understanding the disclosure and accompanying drawings and do not connote or depend on any specific preference, orientation, or order, except where the context clearly indicates otherwise.

As used herein, the term “and/or” means and includes any and all combinations of one or more of the associated listed items.

As used herein, the terms “vertical” and “lateral” refer to the orientations as depicted in the figures.

Energy production devices, in particular, nuclear energy production devices are typically large and require large amounts of space, cooling capacity, etc., to operate. Reducing a size and efficiency of nuclear energy production devices may enable the introduction of nuclear power to rural areas still dependent on fossil fuel based energy, such as oil, coal, and natural gas. For example, nuclear micro reactors are generally only economical at power levels above 1 Megawatt. Increasing the efficiency and reducing the size of a nuclear energy production device may enable nuclear power to become an economical solution for much lower power levels typical of rural areas, business complexes, data centers, remote mines, small military camps, outer space surface missions, etc. In some embodiments, the size of a nuclear energy production device may be reduced by arranging the components of the nuclear energy production device in a way that may eliminate the need for some parts or components of the nuclear energy production device. As many moving parts and/or components are also driven by electricity this may further increase the efficiency of the nuclear energy production device as well. Similarly, reducing the size and increasing the efficiency of the nuclear energy production device may reduce the required amount of fuel reducing the cost of the nuclear energy production device making it more economical.

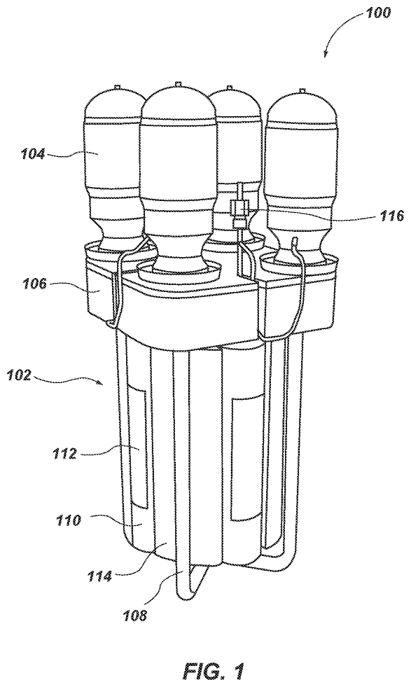

FIG. 1 illustrates an energy production device 100. The energy production device 100 may include a core 102 and one or more energy harnessing devices 104 separated by a heat exchanger 106. The energy production device 100 may be arranged in a vertical orientation, such that the core 102 is in a lower position with the heat exchanger 106 and the energy harnessing devices 104 positioned over the core 102. The energy production device 100 may include down tubes 108 configured to return fluid from the heat exchanger 106 to a bottom portion of the core 102.

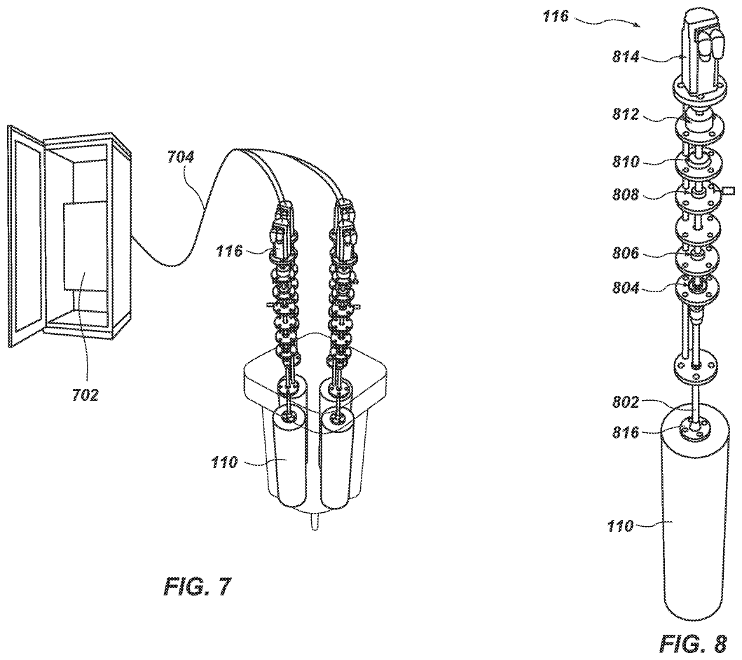

The core 102 may include one or more reaction control devices 110, such as control drums or control rods. The reaction control devices 110 may include a neutron absorbing material 112 on at least a portion of the reaction control devices 110. As described in further detail below, the neutron absorbing material 112 may be configured to absorb neutrons from a nuclear reaction occurring within the core 102 to control, reduce, or even stop the chain reaction of fission occurring within the core 102. The reaction control devices 110 may be controlled through control module 116. For example, the control module 116 may cause control drums to rotate or may insert or withdraw control rods. In some embodiments, the control module 116 may control the reaction control devices 110 based on signals received from a computer or an operator. In some embodiments, the control module 116 may control the reaction based on signals received from sensors within the energy production device 100. In some embodiments, the control module 116 may control the reaction control devices 110 based on a loss of signal or power. Such controls are discussed in further detail below with respect to FIG. 7 and FIG. 8.

The core 102 may also include core shielding 114 configured to reflect loose neutrons back into the core 102 to continue in the fission chain reaction. The core shielding 114 may also serve to reduce the amount of radiation leaving the core 102. Reducing the amount of radiation leaving the core 102 may enable the energy production device 100 to be installed in closer proximity to people, which may reduce the costs of installing and maintaining the energy production device 100.

The core 102 may be configured to heat a heat transmission fluid, such as a liquid metal within the core 102 through the fission chain reaction being controlled within the core 102. The liquid metal may be a metal that is configured to be in a liquid phase at temperatures at or near room temperature, such as sodium potassium eutectic (NaK), Bismuth-Lead-Tin (Bi—Pb—Sn) alloys (e.g., Rose's metal, CERROSAFE, WOOD'S METAL, FIELD'S METAL, CERROLOW (e.g., CERROLOW 136, CERROLOW 117)), Bi—Pb—Sn—Cd—In—Ti, GALINSTAN®. As used herein room temperature is a temperature commonly inhabited by people, such as temperatures between about 15° C. (59° F.) and about 27° C. (80.6° F.), such as from about 20° C. (68° F.) to about 25° C. (77° F.).

The heated heat transmission fluid may flow into the heat exchanger 106 from the core 102. In some embodiments, the energy production device 100 may be configured to induce the heat transmission fluid to flow through natural convection generated by heating the heat transmission fluid. For example, as the fluid is heated the heated fluid may rise above the cooler fluid creating an upward current. The upward current may cause the heated heat transmission fluid to rise into the heat exchanger 106, where the heat in the heat transmission fluid may be transferred to another fluid through the heat exchanger 106. Transferring the heat from the heat transmission fluid may cool the heat transmission fluid. The cooled heat transmission fluid may then travel through down tubes 108 returning to a bottom portion of the core 102 where the heat transmission fluid may again be heated and flow upwards through the core 102. In some embodiments, the natural convection induced current may eliminate the need for a separate pump to move the heat transmission fluid through the core 102. Eliminating a separate pump may reduce the size requirements for the energy production device 100. In some embodiments, eliminating a separate pump may reduce the potential points of failure in the energy production device 100, such as by eliminating the potential for a failed pump as well as the elimination of additional joints in the fluid flow path where leaks may occur.

The heat exchanger 106 may be configured to transfer heat from the heat transmission fluid to a second fluid, such as another liquid or a gas. The heat in the second fluid may be harnessed by the energy harnessing devices 104. For example, the energy harnessing devices 104 may be Stirling engines configured to generate electricity from pressure changes caused by heating a working fluid, such as a helium (He), hydrogen (H), nitrogen (N), methane (CH4), ammonia (NH4), etc. The second fluid may transmit heat to the working fluid through an interface between the heat exchanger 106 and the Stirling engine. In some embodiments, one or more of the energy harnessing devices 104 may be a high grade heat exchanger configured to store the heat or transfer the heat to an external heating application, such as a boiler, hot water heater, heating system (e.g., HVAC heating coil, steam heating system, radiant heating system, etc.), heat storage system (e.g., water tank, etc.), etc.

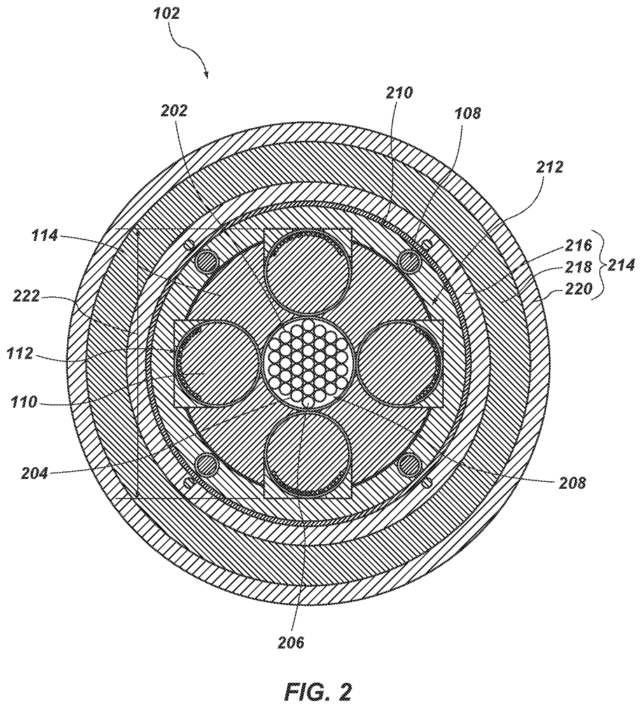

FIG. 2 illustrates a cross-sectional view of the core 102 of the energy production device 100. The core 102 may include a fuel chamber 202 in a central portion of the core 102. The fuel chamber 202 may include space for multiple fuel elements 204, such as fuel rods, fuel pins, fuel pellets, etc. The fuel chamber 202 may also define space around the fuel elements 204 to enable passage of the heat transmission fluid through the fuel chamber 202 to collect heat from the fuel elements 204 as they undergo fission chain reactions. The fuel elements 204 may include a fissile material, such as uranium zirconium hydride (U—ZrH), uranium 235, plutonium-239, etc., configured to facilitate a fission chain reaction.

The fuel chamber 202 may combine with the heat exchanger 106 (FIG. 1) and the down tubes 108 to form a closed fluid loop for the heat transmission fluid. As described above, the heat transmission fluid may be a liquid metal, such as sodium potassium eutectic. The closed fluid loop may also include an inert cover gas, such as argon, configured to maintain an inert atmosphere in the closed fluid loop. In some embodiments, a gas injection system may be configured to circulate cover gas into the heat transmission fluid near the core outlet (e.g., where the heat transmission fluid passes from the fuel chamber 202 to the heat exchanger 106) using a small gas compressor. The gas bubbles of the cover gas above the core may reduce the local density of the heat transmission fluid above the core 102. The bubbles may rise and collect into the cover gas above the core 102. The heat transmission fluid flowing down through the down tubes 108 may then have a relatively higher density difference, increasing a flow rate of the natural convection flow.

The fuel elements 204 may be arranged in multiple concentric rings within the fuel chamber 202, such as two concentric rings, three concentric rings, or four concentric rings. In some embodiments, the concentric rings may be hexagonal in shape. In other embodiments, the concentric rings may be on concentric shapes, such as circular, triangular, square, octagonal, etc. The concentric rings may enable the fuel elements 204 to be densely arranged within the fuel chamber 202, which may result in higher energy production from a smaller energy production device 100. The fuel chamber 202 may include between about 20 fuel elements 204 and about 50 fuel elements 204, such as between about 30 fuel elements 204 and about 40 fuel elements 204, or about 36 fuel elements 204. For example, the fuel chamber 202 may have a diameter of between about 15.25 cm (6 in) and about 25.5 cm (10 in), such as about 20.32 cm (8 in). The density of the arrangement of the fuel elements 204 in the fuel chamber 202 may be sufficient to generate about 100 kilowatts (kW) for between about 4 years and about 10 years, such as about 8 years.

The concentric ring arrangement of fuel element 204 may define a central channel 206 substantially free from fuel elements 204. In some embodiments, sensors or other monitoring devices may be positioned within the central channel 206. In some embodiments, the heat transfer fluid may flow through the central channel 206 as well as through the gaps defined between the fuel elements 204.

The fuel elements 204 may be held in place by one or more reflector inserts 208. The reflector inserts 208 may be positioned between the fuel elements 204 and the side of the fuel chamber 202. In some embodiments, the reflector inserts 208 may be formed from a neutron reflective material such as beryllium (Be), beryllium metals, beryllium oxide (BeO), graphite, steel (e.g., stainless steel), tungsten carbide, magnesium oxide, zirconium deuteride, etc. The reflector insert 208 may substantially limit the number of neutrons leaving the fuel chamber 202, which may increase the efficiency of the fission chain reaction. The reflector inserts 208 may also concentrate flow of the heat transmission fluid to the areas around the fuel elements 204 by substantially limiting open areas around the perimeter of the fuel chamber 202.

The core shielding 114 may substantially surround the fuel chamber 202. The core shielding 114 may be formed from a material configured to reflect neutrons back into the fuel chamber 202 substantially limiting the number of neutrons and/or radiation leaving the fuel chamber 202. For example, the core shielding 114 may include materials, such as beryllium (Be), beryllium oxide (BeO), graphite, steel (e.g., stainless steel), tungsten carbide, magnesium oxide, zirconium deuteride, etc. The core shielding 114 may have a diameter 222 of between about 50 cm (19.69 in) and about 80 cm (31.50 in), or between about 60 cm (23.62 in) and about 70 cm (27.56 in), or about 66 cm (25.98 in).

The reaction control devices 110, may be positioned within the core shielding 114, such that at least a portion of the surface of each of the reaction control devices 110 is proximate the fuel chamber 202. The reaction control devices 110 may be formed from a material similar to the material of the core shielding 114. Therefore, the reaction control devices 110 may include materials, such as beryllium, beryllium oxide, graphite, steel, tungsten carbide, magnesium oxide, zirconium deuteride, etc. At least a portion of an outer surface of the reaction control devices 110 may include a neutron absorbing material 112, such as boron carbide (B4C), xenon, cadmium, hafnium, gadolinium, cobalt, samarium, titanium, dysprosium, erbium, europium, molybdenum, ytterbium, etc. The reaction control devices 110 may be rotationally secured within the core shielding 114, such that the reaction control devices 110 may rotate changing which portion of the surface of the reaction control device 110 is proximate the fuel chamber 202. For example, positioning the neutron absorbing material 112 proximate the fuel chamber 202 may slow or stop the fission chain reaction within the fuel chamber 202 by substantially absorbing the free neutrons. Whereas, positioning the surface including the neutron absorbing material 112 away from the fuel chamber 202 may facilitate the fission chain reaction by positioning a neutron reflective material between the fuel chamber 202 and the neutron absorbing material 112, such that the free neutrons may continue to cause fission in other atoms of the fuel element 204 within the fuel chamber 202.

The core 102 may be surrounded by a secondary containment wall 210 defining a secondary containment area 212. The down tubes 108 may pass through the secondary containment area 212. The secondary containment area 212 may be configured to substantially contain all of the components of the closed fluid loop of the heat transmission fluid. The secondary containment area 212 may be sized such that if the closed fluid loop of the heat transmission fluid leaks, the amount of heat transmission fluid in the core 102 may fill the secondary containment area 212 to a height greater than a height of the fuel elements 204 within the fuel chamber 202, such that the fuel elements 204 may remain substantially submersed in the heat transmission fluid in the event of a failure of any component in the closed fluid loop for the heat transmission fluid.

The secondary containment wall 210 may be surrounded by additional shielding layers 214 formed from different materials having different properties. For example, an inner shielding layer 216 proximate the secondary containment wall 210 may be formed from a neutron reflective material, such as steel, beryllium, beryllium oxide, graphite, tungsten carbide, magnesium oxide, zirconium deuteride, etc. In some embodiments, the inner shielding layer 216 may be formed from a different material from the core shielding 114. In other embodiments, the inner shielding layer 216 may be formed from substantially the same material as the core shielding 114. Thus, the inner shielding layer 216 may be configured to reflect any stray neutrons back toward the fuel chamber 202.

An intermediate shielding layer 218 may surround the inner shielding layer 216. The intermediate shielding layer 218 may be formed from a neutron absorbing material, such as boron carbide, xenon, cadmium, hafnium, gadolinium, cobalt, samarium, titanium, dysprosium, erbium, europium, molybdenum, ytterbium, etc. The intermediate shielding layer 218 may be configured to absorb any stray neutrons that may pass through the inner shielding layer 216.

An outer shielding layer 220 may surround the intermediate shielding layer 218. The outer shielding layer 220 may be formed from a neutron reflective material, such as steel, beryllium, beryllium oxide, graphite, tungsten carbide, magnesium oxide, zirconium deuteride, etc. In some embodiments, the outer shielding layer 220 may be formed from a different material from the core shielding 114 and/or the inner shielding layer 216. In other embodiments, the outer shielding layer 220 may be formed from substantially the same material as the core shielding 114 and/or the inner shielding layer 216. The outer shielding layer 220 may be configured to reflect any stray neutrons that are not reflected by the inner shielding layer 216 or absorbed by the intermediate shielding layer 218 toward the inner shielding layer 216, such that the neutrons may be absorbed by the intermediate shielding layer 218, continue reflecting between the inner shielding layer 216 and the outer shielding layer 220, or pass through the inner shielding layer 216 back toward the fuel chamber 202. The additional shielding layers 214 may substantially limit the amount of stray neutrons and/or radiation leaving the core 102. The diameter of the core 102 including the additional shielding layers 214 may be between about 66 cm (25.98 in) and about 91.44 cm (36 in), such as about 76.2 cm (30 in).

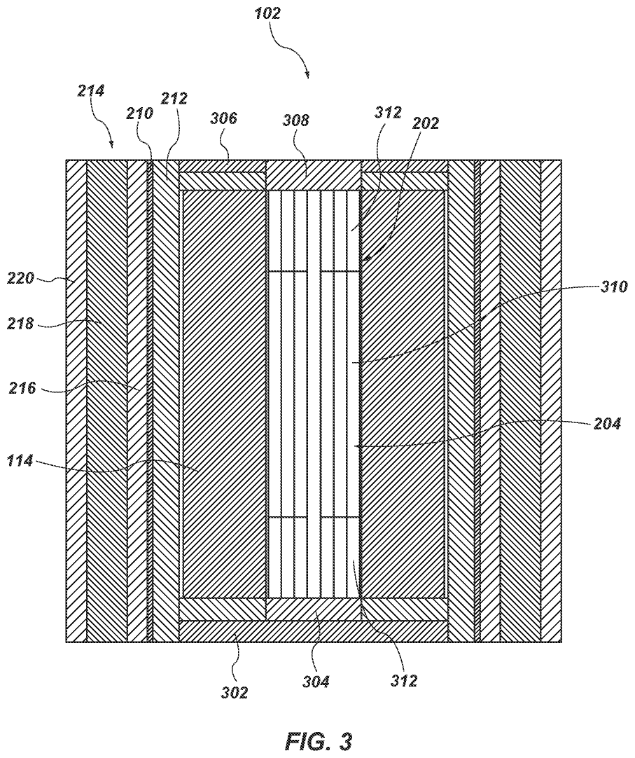

FIG. 3 illustrates a side cross-sectional view of the core 102. As described above, the core 102 may be surrounded by the additional shielding layers 214 that may be configured to substantially prevent stray neutrons and/or radiation from leaking radially out of the core 102. The core 102 may similarly include a base plate 302 and a top plate 306 configured to substantially limit stray neutrons from leaking axially from the core 102. For example, the base plate 302 and/or the top plate 306 may be formed from a neutron reflective material, such as steel, beryllium, beryllium oxide, graphite, tungsten carbide, magnesium oxide, zirconium deuteride, etc.

The base plate 302 may define a fluid inlet 304. The fluid inlet 304 may be configured to receive the heat transmission fluid from the down tubes 108 (FIGS. 1 and 2). The fluid inlet 304 may be a plenum, such as a reservoir, cavity, etc., configured to collect and/or store the heat transmission fluid until the heat transmission fluid is drawn into the fuel chamber 202 by the induced current. For example, the heat transmission fluid may enter the fluid inlet 304 from the down tubes 108 after having been cooled in the heat exchanger 106. As the heat transmission fluid in the fuel chamber 202 collects heat from the fuel elements 204, the heat transmission fluid may move upward due to convection. As the heat transmission fluid moves upward the cooled heat transmission fluid in the fluid inlet 304 may then be drawn into the fuel chamber 202 to begin collecting heat from the fuel elements 204.

The top plate 306 may define a fluid outlet 308. The fluid outlet 308 may be configured to receive the heated heat transmission fluid from the fuel chamber 202 after the heat transmission fluid has collected heat from the fuel elements 204 while traveling up through the fuel chamber 202. The fluid outlet 308 may be a plenum similar to the fluid inlet 304 configured to collect and/or store the heat transmission fluid until the heat transmission fluid is pushed into the heat exchanger 106 by more heat transmission fluid exiting the fuel chamber 202. In some embodiments, the fluid outlet 308 may also include an inert cover gas, such as argon. The inert cover gas may be configured to limit radiation effects, and to integrate instrumentation for monitoring and reporting relevant thermal-hydraulic parameters, such as temperatures, flow rates, pressures, etc.

The fuel elements 204 may include axial reflectors 312 on opposing axial ends of the fuel element 204. The axial reflectors 312 may be formed from a neutron reflective material, such as steel, beryllium, beryllium metals, beryllium oxide, graphite, tungsten carbide, magnesium oxide, zirconium deuteride, etc. The fuel element 204 may also include fuel 310, such as fuel 310 in the form of pellets arranged axially within a tubular encasement sandwiched between the axial reflectors 312. The fuel 310 portion of the fuel element 204 may have a length between about 40 cm (about 15.75 in) and about 60 cm (about 23.62 in), such as about 51 cm (about 20.08 in). The fuel element 204 including the axial reflectors 312 may have a total length of between about 80 cm (about 31.50 in) and about 100 cm (about 39.37 in), such as about 91 cm (about 35.83 in).

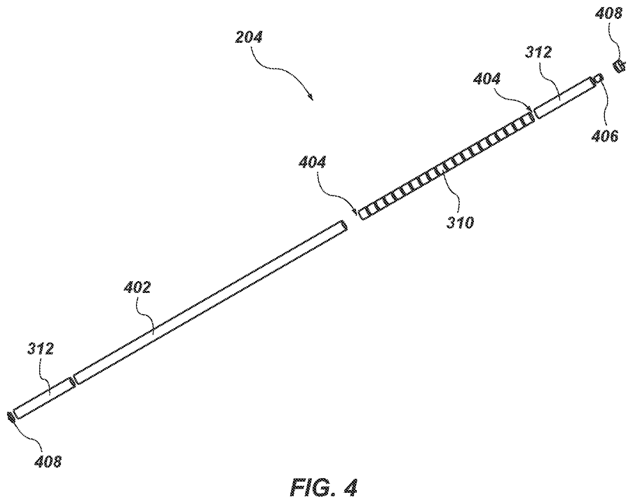

FIG. 4 illustrates an exploded view of a fuel element 204 illustrating the different elements of the fuel element 204. As described above, the fuel element 204 may include two axial reflectors 312 on opposing ends of the fuel element 204 and fuel 310 arranged between the two opposing axial reflectors 312. The fuel 310 may be cylindrical pellets of fuel, such as uranium zirconium hydride (U—ZrH), uranium 235, plutonium-239, etc. For example, the fuel may be a uranium zirconium hydride (UZrHx) containing about 30 and about 40 wt % U and enriched to about 19.75%. Each fuel pellet may have a diameter between about 28 mm (about 1.10 in) and about 30 mm (about 1.18 in), such as about 29.72 mm (about 1.17 in) and a length between about 26 mm (1.02 in) and about 30 mm (about 1.18 in), such as about 27.97 mm (about 1.1 in). Each fuel element 204 may contain between about 15 fuel pellets and about 20 fuel pellets, such as about 18 fuel pellets.

The cylindrical pellets of fuel may be arranged in a coaxial stack. The fuel 310 may include diffusion barriers 404 on opposing ends of the stack of cylindrical pellets of fuel. In some embodiments, the diffusion barriers 404 may be a plenum space configured to accumulate any released fission gases and gaseous hydrogen released during fission reactions of the fuel 310. The fuel element 204 may also include a biasing element 406, such as a spring, a compressible fluid, spring washers, etc. The biasing element 406 may be configured to enable expansion of the elements of the fuel element 204, such as to accumulate any released fission gases and gaseous hydrogen released during fission reactions of the fuel 310.

The axial reflectors 312 may have a diameter between about 28 mm (about 1.10 in) and about 30 mm (about 1.18 in), such as about 29.72 mm (about 1.17 in) and a length of between about 76.2 mm (about 3 in) and about 127 mm (about 5 in), such as about 101.60 mm (about 4 in). As described above, the axial reflectors 312 may be formed from a neutron reflective material, such as steel, beryllium, beryllium metals, beryllium oxide, graphite, tungsten carbide, magnesium oxide, zirconium deuteride, etc.

The fuel element 204 may be encased in cladding 402 enclosed with end caps 408. The cladding 402 and the end caps 408 may be formed from substantially the same material. For example, the cladding 402 and the end cap 408 may be formed from a stainless steel alloys (e.g., SS 316) or other metal alloys (e.g., nickel-iron-chrome alloys, INCOLOY®, INCOLOY800®, etc.).

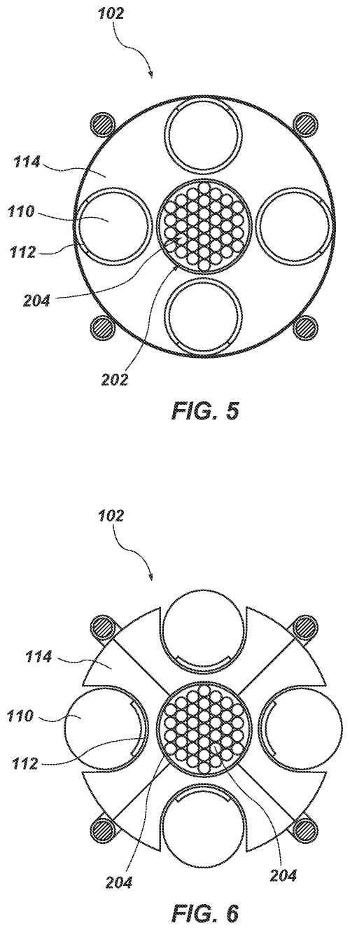

FIGS. 5 and 6 illustrate cross-sections of the core 102 in two different control orientations. FIG. 5 illustrates the core 102 with the reaction control devices 110 in the least limiting position. As illustrated in FIG. 5, the least limiting position of the reaction control device 110 may be positioning the portion of each of the reaction control devices 110 including the neutron absorbing material 112 in a position the greatest distance from the fuel chamber 202. In this orientation free neutrons within the fuel chamber 202 may be reflected from the core shielding 114 back into the fuel chamber 202 to continue to cause fission chain reactions in the fuel elements 204 within the fuel chamber 202.

FIG. 6 illustrates the core 102 with the reaction control devices 110 in the most limiting position. As illustrated in FIG. 6, the most limiting position of the reaction control devices 110 may be positioning the portion of each of the reaction control devices 110 including the neutron absorbing material 112 in a position proximate the fuel chamber 202. In this orientation the free neutrons within the fuel chamber 202 may be absorbed by the neutron absorbing material 112, such that the free neutrons are no longer free (e.g., are limited) to cause fission reactions in the fuel elements 204.

In some embodiments, the reaction control devices 110 may each be configured to include sufficient neutron absorbing material 112 that any one reaction control device 110 may absorb sufficient neutrons to stop chain reactions from occurring within the fuel chamber 202. In some embodiments, the reaction control devices 110, may be configured such that any two reaction control devices 110 may include sufficient neutron absorbing material 112 to stop the chain reactions within the fuel chamber 202.

In some embodiments, the reaction control devices 110 may be configured to operate individually, such that each of the reaction control devices 110 may rotate independent of the other reaction control devices 110. In some embodiments, the reaction control devices 110 may be configured to operate in pairs. For example, opposing reaction control devices 110 may be configured to rotate in substantially the same manner and the pair may be configured to rotate substantially independent of the other pair(s) of reaction control devices 110. In another embodiment, a pair of adjacent reaction control devices 110 may be configured to rotate in substantially the same manner while being configured to rotate substantially independent of the other pair(s) of reaction control devices 110. In some embodiments, all of the reaction control devices 110 may be configured to rotate together in substantially the same manner.

The reaction control devices 110 may be configured to fail to the position shown in FIG. 6. For example, in a fail condition, such as a loss of power, loss of control signal, etc., the reaction control devices 110 may each turn to the most limiting position configured to substantially stop the chain reactions in the fuel chamber 202.

FIG. 7 illustrates a schematic view of a control system for the reaction control devices 110. The reaction control devices 110 may each be driven by an individual control module 116. The control module 116 may be configured to turn the respective reaction control device 110 moving the neutron absorbing material 112 closer to or farther away from the fuel chamber 202 to control the fission reactions within the fuel chamber 202.

The control modules 116 may receive the respective signals from a controller 702 through control wiring 704. The controller 702 may be configured to receive operational data from the energy production device 100 from sensors in different portions of the energy production device 100. For example, the sensor data may include flow rates of the heat transmission fluid, temperatures of the fuel chamber 202, heat transmission fluid, heat exchanger 106, energy harnessing devices 104, etc., energy production, energy stored, energy load, criticality of the reactions in the fuel chamber 202, etc. In some embodiments, the controller 702 may operate in a substantially automated mode, such that the controller 702 may adjust the positions of the reaction control devices 110 to maintain a criticality of the energy production device 100 and regulate the power output without operator intervention.

In some embodiments, the controller 702 may be configured to detect safety related situations, such as seismic events, power losses, leaks, etc., and turn the reaction control devices 110 to the most limiting position substantially stopping the fission reactions within the fuel chamber 202. The controller 702 may also be configured to alert an operator to the safety condition, such as through an alarm (e.g., alarm sound, alarm light, alarm message displayed at a control panel, alarm message sent to a mobile device, etc.). In some embodiments, an operator may override control of the energy production device 100, such as through an operator interface. For example, the operator may initiate a shut down or deactivate a specific control module 116 associated with a reaction control device 110, such as for maintenance, repairs, etc.

FIG. 8 illustrates a view of a control module 116 associated with a reaction control device 110. The control module 116 may include a motor 814 coupled to the reaction control device 110 through a drive shaft 802. The motor 814 may be an electric motor, such as a direct current motor (DC motor) or stepper motor. In some embodiments, the motor 814 may include an integrated gear box configured to increase the torque output from the motor 814 while decreasing the rotational speed of the drive shaft 802.

The drive shaft 802 may be configured to be rotationally secured to the reaction control device 110. For example, the reaction control device 110 may include a coupler 816 configured to rotationally secure the reaction control device 110 to the drive shaft 802. In some embodiments, the drive shaft 802 may include interfacing geometry, such as splines, keys, key ways, etc., and the coupler 816 may include complementary interface geometry, such as reverse splines, key ways, keys, etc.

The interface between the motor 814 and the drive shaft 802 may include a clutch 812. The clutch 812 may be configured to absorb shock between the motor 814 and the drive shaft 802 when the motor 814 starts and stops. In some embodiments, the clutch 812 may be configured to substantially prevent the motor 814 from stalling when starting to turn or making small rotational adjustments.

The control module 116 may also include one or more sensors 810, such as position sensors, strain sensors, temperature sensors, pressure sensors, etc. The sensors 810 may be coupled to the controller 702 through the control wiring 704, such that the controller 702 may receive sensor data from the sensor 810 and control the control module 116 at least partially based on the data produced by the one or more sensors 810. In some embodiments, the sensors 810 may enable the controller 702 to diagnose problems with the control modules 116, such as identifying when the reaction control devices 110 are not changing position responsive to control signals.

The control module 116 may include one or more shock absorbers 808. The shock absorbers 808 may be configured to absorb rotational shock from sudden starts or stops of the motor 814. In some embodiments, the shock absorbers 808 may be configured to absorb shock from vibrations in the energy production device 100. For example, the shock absorbers 808 may be configured to substantially protect electrical connections and/or mechanical connections from fatigue due to vibrations within the energy production device 100.

In some embodiments, the control module 116 may include limit switches 806. For example, the limit switches 806 may be configured to provide a binary input (e.g., on/off input) to the controller 702 identifying when the reaction control device 110 is in the most limiting position or in the least limiting position. In some embodiments, the limit switches 806 may be configured to cause the motor 814 to reverse directions. In some embodiments, the limit switches 806 may enable the controller 702 to identify if the reaction control device 110 has rotated to most limited position without a control signal, such as due to a control failure.

The control module 116 may also include a biasing element 804, such as a spring. The biasing element 804 may be configured to bias the control module 116 and the reaction control device 110 to the most limiting position as discussed above. The biasing element 804 may be configured to cause the reaction control device 110 to rotate to the most limiting position if a failure causes the motor 814 to not continue driving the drive shaft 802, such as a power failure or control signal failure.

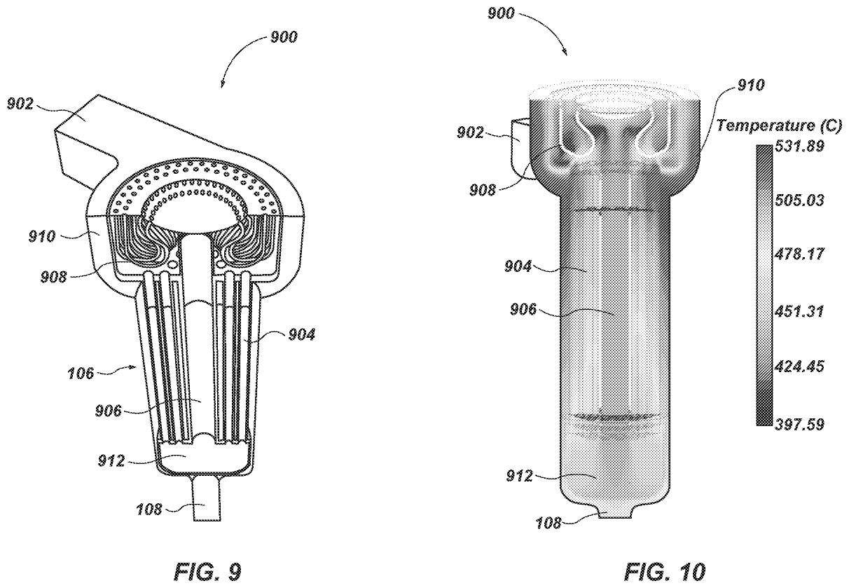

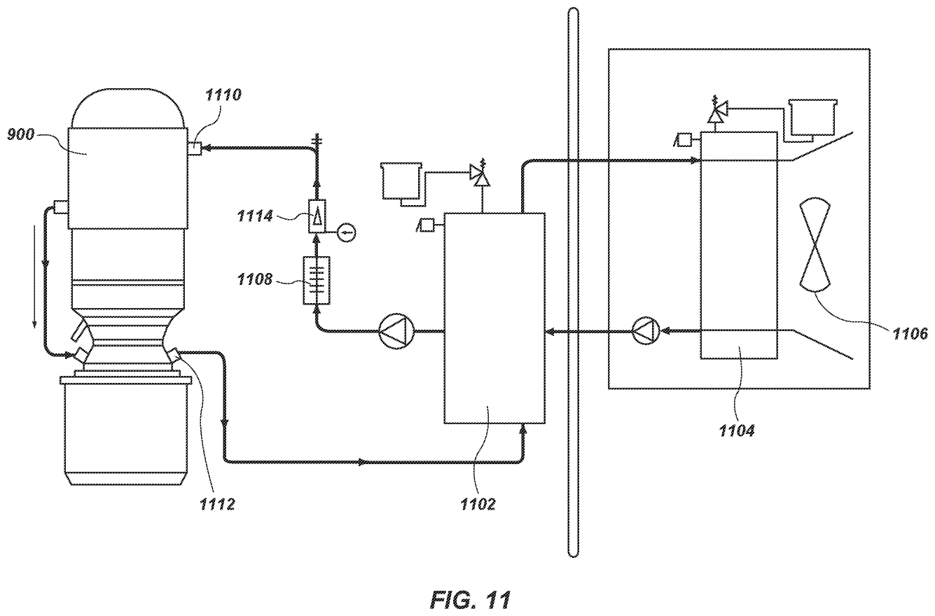

FIGS. 9 and 10 illustrate cross-sectional views of a Stirling engine 900, which may be used as the energy harnessing device 104 described above. FIG. 9 illustrates a perspective view of the cross-section of the Stirling engine 900 and FIG. 10 illustrates a finite element model (FEA) analysis of the heat transfer within the Stirling engine 900. Stirling engines may be configured to generate electricity from pressure changes caused by heating a working fluid, such as a helium (He), nitrogen (N), methane (CH4), ammonia (NH4), etc. For example, a Stirling engine may convert pressure changes caused by cyclically heating and cooling the working fluid into mechanical work, such as linear motion. The mechanical work may then be converted into electricity through processes such as moving magnets over wire coils, etc.

The heat transmission fluid may enter the Stirling engine 900 through a flow inlet 902, which may be coupled to the fluid outlet 308 of the core 102 (FIG. 3). The heat transmission fluid may flow from the flow inlet 902 through the heat exchanger 106 and into the down tube 108 to return to the core 102. The heat exchanger 106 may include an upper plenum 910, a lower plenum 912, secondary risers 904, and a secondary downtube 906. The heat transmission fluid may first collect in the upper plenum 910 creating the hottest region of the primary side of the heat exchanger 106. The heat transmission fluid may then travel downward through the heat exchanger 106 around the secondary risers 904 transferring heat from the heat transmission fluid to a secondary fluid within the heat exchanger 106 before collecting in the lower plenum 912, which may be the coolest region of the primary side of the heat exchanger 106. The cooled heat transmission fluid may then exit the heat exchanger 106 through the down tube 108.

The secondary fluid may flow through the secondary risers 904 absorbing heat from the heat transmission fluid in the heat exchanger 106. As the secondary fluid absorbs the heat, the secondary fluid may rise through the heat exchanger 106 under natural convection similar to the heat transmission fluid in the core 102. The temperature of the heat transmission fluid may increase as the secondary fluid rises higher in the secondary risers 904. Thus, as the secondary fluid reaches a top portion of the heat exchanger 106 proximate the Stirling engine 900, the secondary fluid may be at its highest temperature.

The secondary fluid may be isolated from both the heat transmission fluid and the working fluid of the Stirling engine 900. The isolated secondary fluid may enable an operator to remove the Stirling engine 900, such as for maintenance or replacement without shutting down the energy production device 100. Similarly, the isolated secondary fluid may enable the energy production device 100 to be modular having some of the energy harnessing devices 104 configured as Stirling engines 900 and some of the energy harnessing devices 104 configured as high grade heat exchangers.

In some embodiments, the secondary fluid may be an unreactive liquid metal, such as Lead-Bismuth Eutectic (LBE). The secondary fluid may also be selected for radiation shielding properties of the fluid.

The heat from the secondary fluid may be absorbed by Stirling coils 908 of the Stirling engine 900. The Stirling coils 908 may include the working fluid of the Stirling engine 900. As the working fluid absorbs the heat from the secondary fluid through the Stirling coils 908, the working fluid pressure may increase causing the working fluid to expand generating mechanical work in the Stirling engine 900. The expansion of the working fluid may reduce the temperature of the working fluid. Excess heat in the working fluid that was not release from the expansion of the working fluid may be removed through an external cooling system, described in further detail below with respect to FIG. 11.

The Stirling engine 900 may be configured to begin producing electrical power at temperatures above about 250° C. (482° F.) at the interface between the secondary fluid and the Stirling coils 908. The Stirling engine 900 may be configured to generate between about 5 kilowatts (kW) and about 7.1 kW of power at temperatures above about 500° C. (about 932° F.) at the interface between the secondary fluid and the Stirling coils 908.

As illustrated in FIG. 1, the energy production device 100 may include multiple Stirling engines 900 in the energy harnessing device 104 mounted over the core 102. An engine control unit (ECU) may be configured to adjust a power output of the energy production device 100 by staging the Stirling engines 900, such that a power output of the energy production device 100 may be reduced down to about 5 kW by staging on only one Stirling engine 900 and reducing the fission reactions in the core 102 to maintain a lower heat load for the reduced cooling. Similarly, the modularity of the energy production device 100 may enable one or more of the Stirling engines 900 to be removed and/or replaced with high grade heat exchangers configured to remove and/or store heat from the energy production device 100 for other purposes, such as heating processes in manufacturing, water heating, boilers, etc. Exchanging Stirling engines 900 for high grade heat exchangers may reduce the electrical power output from the energy production device 100 while still making use of the additional heat expelled from the core 102.

Similar to staging the multiple Stirling engine 900, if higher energy production is needed, such as due to expansion and/or growing energy needs, additional energy production devices 100 may be coupled to the energy production device 100 in series or parallel such that the associated Stirling engines 900 may similarly be staged on and off increasing the energy production capabilities of the system.

FIG. 11 illustrates a schematic view of a cooling system for the Stirling engine 900. As described above, after the working fluid expands generating the work within the Stirling engine 900, the working fluid may still have excess heat that may need to be removed from the working fluid. The Stirling engine 900 may include a cooling system configured to remove the excess heat from the working fluid.

The cooling system may flow a cooling fluid, such as water, glycol, etc., through the Stirling engine 900 to remove excess heat from the working fluid. The cooling fluid may enter the Stirling engine 900 through a cooling inlet 1110, pass over the working fluid in a heat rejection region of the Stirling engine 900 and exit through a cooling outlet 1112 after having absorbed the excess heat from the working fluid.

The cooling fluid may then enter a heat exchanger 1102, such as a liquid to liquid heat exchanger, plate heat exchanger, etc., to transfer the heat to a secondary fluid. In some embodiments, the heat exchanger 1102 may enable the cooling fluid to be treated and or maintained in a manner to reduce, damage, scale buildup, oxidation, etc., within the Stirling engine 900. In some embodiments, the heat exchanger 1102 may facilitate the exchange of heat from an interior cooling system (e.g., water system), to an exterior system, such as a freeze protected system or glycol system. In some embodiments, the heat exchanger 1102 may enable the exchange of heat from a closed loop system to an open loop system, such as a cooling tower for rejecting the heat through evaporation.

The secondary fluid may be configured to remove the excess heat through a secondary heat exchanger 1104, such as a liquid to air heat exchanger (e.g., fan coil). The liquid to air heat exchanger may include a fan 1106 configured to force air through the secondary heat exchanger 1104 removing the excess heat from the secondary fluid with the air flow over the secondary heat exchanger 1104. In some embodiments, the removed heat may be used to heat a space, such as a building, a warehouse, a garage, etc. In some embodiments, the secondary heat exchanger 1104 may be another liquid to liquid heat exchanger. For example, the secondary heat exchanger 1104 may be configured to heat water or process fluids, such as a water heater or a boiler. In some embodiments, the heat exchanger 1102 may be configured to heat water or other process fluids and any excess heat not used in heating the heated water or process fluid may then be rejected (e.g., dissipated or transferred to another area, space, or element) through the secondary heat exchanger 1104. In some embodiments, the cooling fluid may pass directly to the secondary heat exchanger 1104 without the intervening heat exchanger 1102.

The cooling fluid may also be configured to remove heat from electronic components of the Stirling engine 900, such as an engine control unit (ECU) 1108. The cooling fluid may pass over or through the cooling elements of the ECU 1108 before passing through the Stirling engine 900. The cooling system may also include sensors 1114, such as flow sensors, temperature sensors, flow switches, pressure sensors, etc. The sensors 1114 may be configured to monitor the cooling fluid at different points in the cooling system, such as before and after each heating load or heat exchanger. For example, the cooling system may monitor cooling fluid temperatures, pressure, etc., between the heat exchanger 1102 and the ECU 1108, between the ECU 1108 and the Stirling engine 900, and/or between the Stirling engine 900 and the heat exchanger 1102. The secondary fluid may also include sensors such as flow sensors, temperature sensors, flow switches, pressure sensors, etc., at similar intervals in the secondary fluid loop. For example, the secondary fluid loop may include sensors for temperature, pressure, etc., between the heat exchanger 1102 and the secondary heat exchanger 1104, and/or between the secondary heat exchanger 1104 and the heat exchanger 1102.

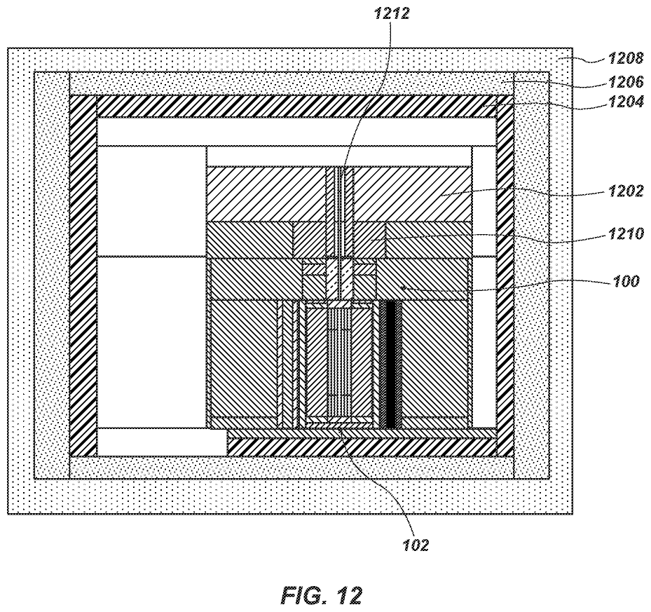

FIG. 12 illustrates additional safety systems and structures that may be used to protect people and operators working and/or living near the energy production device 100. As described above, the core 102 of the energy production device 100 may include multiple layers of shielding materials configured to substantially limit the amounts of radiation leaving the core 102. The relatively small size of the energy production device 100 may enable the energy production device 100 to be installed within a casing 1206 that may include additional shielding layers. For example, the energy production device 100 may be about less than about 3 m (about 9.84 ft) tall, such as about 2.44 m (about 8 ft) tall and have a diameter between about 66 cm (about 25.98 in) and about 91.44 cm (about 36 in), such as about 76.2 cm about (30 in). This relatively small size may enable the energy production device 100 to be transported in a standard shipping container or even in an aircraft.

The casing 1206 may be formed from a structural material, such as concrete (e.g., Class B concrete). The 1206 may have a thickness of between about 30 cm (about 11.81 in) and about 40 cm (about 15.748 in), such as between about 30.48 cm (about 12 in) and about 35.6 cm (about 14 in). The casing 1206 may provide structural support surrounding the energy production device 100, such that the casing 1206 enclosing the energy production device 100 may be placed underground. The casing 1206 may be substantially surrounded by earth 1208, such as sand, which may provide additional shielding from any radiation that may leak from the casing 1206.

The casing 1206 may include insulation 1204 lining the casing 1206 between the casing 1206 and the energy production device 100. The insulation 1204 may be formed from a neutron shielding material, such as borated polyethylene. The insulation 1204 may have a thickness of between about 10 cm (about 3.94 in) and about 40 cm (about 15.75 in), such as between about 15 cm (about 5.91 in) and about 25 cm (about 9.84 in).

The casing 1206 may include additional shielding layers positioned over the energy production device 100, such as a radiation shield 1202 and a reflective shield 1210. The radiation shield 1202 may be formed from a material with high density and other radiation shielding properties, such as lead. The radiation shield 1202 may be positioned axially above the energy production device 100 to substantially limit the amount radiation and/or neutrons leaving the energy production device 100 in an upward direction. The radiation shield 1202 may have a thickness of between about 20 cm (about 7.87 in) and about 50 cm (about 19.69 in), such as between about 25 cm (about 9.84 in) and about 35 cm (about 13.78 in).

The reflective shield 1210 may be formed from a neutron reflective material, such as steel (e.g., stainless steel, SS 316, INCOLOY 800®, etc.), beryllium, beryllium metals, beryllium oxide, graphite, tungsten carbide, magnesium oxide, zirconium deuteride, etc. The reflective shield 1210 may be positioned between the radiation shield 1202 and the energy production device 100. The reflective shield 1210 may have a thickness of between about 20 cm (about 7.87 in) and about 50 cm (about 19.69 in), such as between about 25 cm (about 9.84 in) and about 35 cm (about 13.78 in).

The energy production device 100 may also include additional safety shut down features. For example, the energy production device 100 may include a secondary shutdown feature. As described above, the energy production device 100 may be constructed such that any one of the reaction control devices 110 may have sufficient neutron absorbing material 112 to stop the fission reactions within the core 102. Furthermore, each of the reaction control devices 110 may be configured to fail in the most limiting position, which may cause the fission reactions within the core 102 to stop. Thus, the energy production device 100 may include at least four levels of redundancy for shutting down the energy production device 100. The energy production device 100 may further include a shutdown rod 1212. The shutdown rod 1212 may be formed entirely from a neutron-absorbing material, such as boron carbide (B4C), xenon, cadmium, hafnium, gadolinium, cobalt, samarium, titanium, dysprosium, erbium, europium, molybdenum, ytterbium, etc. The shutdown rod 1212 may be configured to drop into the fuel chamber 202 under a failure condition, such as a loss of power, seismic event, emergency shut down command, etc., effectively absorbing all of the stray neutrons and stopping any fission reactions from occurring within the core 102.

Embodiments of the present disclosure may be smaller, more modular nuclear energy production devices. Making energy production devices smaller and more modular may facility the use of nuclear energy production devices in a larger variety of situations, locations, etc. Making the energy production device smaller may also result in easier transportation and field assembly, as the devices may be transported in a substantially assembled form rather than in multiple pieces requiring expert assembly. Making energy production devices more modular may also increase the ease of working on and/or customizing the energy production devices to specific locations and needs without the expense of custom building and/or designing energy production devices for each location or need.

The embodiments of the present disclosure, may have fewer moving parts, reduced cooling needs, and reduced space requirements. Reducing the number of moving parts may decrease the potential points of failure leading to a more robust energy production device that may also be easier to maintain and/or customize without specialized training. Reducing the cooling needs, may enable the energy producing devices to be placed in more rural areas without access to large bodies of water to absorb or dissipate large amounts of heat.

Embodiments of the present disclosure may produce energy more efficiently, such that they may be economical at lower energy production rates. Making energy production more economical at lower energy production rates may enable smaller facilities, communities, etc., to take advantage of the advantages of clean nuclear power in rural areas where energy loads are substantially less than the Megawatt range considered economical for larger nuclear power plants.

Non-limiting example embodiments of the present disclosure may include:

Embodiment 1: An energy production device comprising: a core comprising: one or more fuel rods; and a heat transmission fluid configured to flow through natural convection upwards through the one or more fuel rods and collect heat therefrom; a reaction control device including a neutron-absorbing material; a heat exchanger positioned over the core configured to receive the heat transmission fluid and transfer the heat to an energy harnessing device positioned on an opposite side of the heat exchanger from the core.

Embodiment 2: The energy production device of embodiment 1, wherein the heat transmission fluid comprises a metal material configured to be in a liquid phase at room temperature.

Embodiment 3: The energy production device of any one of embodiments 1 or 2, wherein the reaction control device comprises one or more control drums arranged radially about the core.

Embodiment 4: The energy production device of any one of embodiments 1 through 3, wherein the reaction control device comprises at least two reaction control devices.

Embodiment 5: The energy production device of embodiment 4, wherein any one of the at least two reaction control devices includes sufficient neutron-absorbing material to stop a fission chain reaction within the core.

Embodiment 6: The energy production device of any one of embodiments 1 through 5, wherein the heat transmission fluid is configured to flow through natural convection induced by heating the heat transmission fluid in the core and cooling the heat transmission fluid in the heat exchanger.

Embodiment 7: The energy production device of any one of embodiments 1 through 6, wherein the energy harnessing device comprises a Stirling engine configured to convert the heat to electrical energy.

Embodiment 8: The energy production device of any one of embodiments 1 through 7, wherein the energy harnessing device comprises a high grade heat exchanger configured to harness the heat to heat external components or spaces or to provide the heat to a heat storage system.

Embodiment 9: The energy production device of any one of embodiments 1 through 8, further comprising a secondary containment area defined by a secondary containment wall, wherein the secondary containment area substantially surrounds the core and all components associated with the heat transmission fluid.

Embodiment 10: The energy production device of embodiment 9, wherein the secondary containment area is sized such that if the heat transmission fluid leaks into the secondary containment area, a level of the heat transmission fluid will substantially cover the fuel rods while filling the secondary containment area with the heat transmission fluid.

Embodiment 11: An energy production device comprising: a core comprising: one or more fuel rods; and a heat transmission fluid configured to flow around the one or more fuel rods and collect heat therefrom; a reaction control device including a neutron-absorbing material; a heat exchanger positioned over the core configured to receive the heat transmission fluid and transfer the heat to an intermediate fluid; an energy harnessing module removably coupled to the heat exchanger, the energy harnessing module configured to capture or convert heat energy from the intermediate fluid; and a control system configured to control the reaction control device and energy harnessing module.

Embodiment 12: The energy production device of embodiment 11, wherein the intermediate fluid comprises a liquid metal material.

Embodiment 13: The energy production device of embodiment 12, wherein the liquid metal material comprises Lead-Bismuth Eutectic (LBE).

Embodiment 14: The energy production device of any one of embodiments 11 through 13, wherein the energy harnessing module comprises at least two energy harnessing modules.

Embodiment 15: The energy production device of embodiment 14, wherein the control system is configured to control energy production of the energy production device by staging the at least two energy harnessing modules.

Embodiment 16. The energy production device of any one of embodiments 14 or 15, wherein the at least two energy harnessing modules comprise different types of energy harnessing modules.

Embodiment 17: The energy production device of any one of embodiments 14 through 16, wherein the at least two energy harnessing modules comprise at least one of a Stirling engine and a high grade heat exchanger.

Embodiment 18: The energy production device of any one of embodiments 11 through 17, wherein the core further comprises an inert gas over the heat transmission fluid.

Embodiment 19: A method of harnessing nuclear energy comprising: controlling a nuclear fission reaction in a core including fuel rods; causing a heat transmission fluid to flow upwards through the core through natural convection by heating the heat transmission fluid with the controlled nuclear fission reaction; cooling the heat transmission fluid by transferring heat to an energy harnessing device through a heat exchanger positioned over the core; harnessing the heat from the heat exchanger for storage, transmission, or conversion into another form of energy with the energy harnessing device; flowing the heat transmission fluid through a downtube separate from the fuel rods after cooling the heat transmission fluid; and re-introducing the cooled heat transmission fluid below the fuel rods.

Embodiment 20: The method of embodiment 19, wherein cooling the heat transmission fluid by transferring heat to the energy harnessing device further comprises: cooling the heat transmission fluid by transferring heat to an intermediate fluid in the heat exchanger; and transferring the heat from the intermediate fluid to the energy harnessing device through the heat exchanger.

The embodiments of the disclosure described above and illustrated in the accompanying drawing figures do not limit the scope of the invention, since these embodiments are merely examples of embodiments of the invention, which is defined by the accompanying claims and their legal equivalents. Any equivalent embodiments are intended to be within the scope of this disclosure. Indeed, various modifications of the present disclosure, in addition to those shown and described herein, such as alternative useful combinations of the elements described, may become apparent to those skilled in the art from the description. Such modifications and embodiments are also intended to fall within the scope of the accompanying claims and their legal equivalents.

1. An energy production device comprising:
a core comprising:
one or more fuel rods;
a heat transmission fluid configured to flow through natural convection upwards through the one or more fuel rods and collect heat therefrom; and
a reaction control device including a neutron-absorbing material; and
a heat exchanger positioned over the core and configured to receive the heat transmission fluid and transfer the heat to an energy harnessing device positioned on an opposite side of the heat exchanger from the core.

2. The energy production device of claim 1, wherein the heat transmission fluid comprises a metal material configured to be in a liquid phase at room temperature.

3. The energy production device of claim 1, wherein the reaction control device comprises one or more control drums arranged radially about the core.

4. The energy production device of claim 1, wherein the reaction control device comprises at least two reaction control devices.

5. The energy production device of claim 4, wherein any one of the at least two reaction control devices includes sufficient neutron-absorbing material to stop a fission chain reaction within the core.

6. The energy production device of claim 1, wherein the heat transmission fluid is configured to flow through natural convection induced by heating the heat transmission fluid in the core and cooling the heat transmission fluid in the heat exchanger.

7. The energy production device of claim 1, wherein the energy harnessing device comprises a Stirling engine configured to convert the heat to electrical energy.

8. The energy production device of claim 1, wherein the energy harnessing device comprises a heat exchanger configured to harness the heat to heat external components or spaces or to provide the heat to a heat storage system.

9. The energy production device of claim 1, further comprising a secondary containment area defined by a secondary containment wall, wherein the secondary containment wall substantially surrounds the core and all components associated with the heat transmission fluid.

10. The energy production device of claim 9, wherein the secondary containment area is sized such that if the heat transmission fluid leaks into the secondary containment area, a level of the heat transmission fluid will substantially cover the fuel rods while filling the secondary containment area with the heat transmission fluid.

11. An energy production device comprising:
a core comprising:
one or more fuel rods;
a heat transmission fluid configured to flow around the one or more fuel rods and collect heat therefrom; and
a reaction control device including a neutron-absorbing material; and
a heat exchanger positioned over the core and configured to receive the heat transmission fluid and transfer the heat to an intermediate fluid;
an energy harnessing module removably coupled to the heat exchanger, the energy harnessing module configured to capture or convert heat energy from the intermediate fluid; and
a control system configured to control the reaction control device and energy harnessing module.

12. The energy production device of claim 11, wherein the intermediate fluid comprises a liquid metal material.

13. The energy production device of claim 12, wherein the liquid metal material comprises Lead-Bismuth Eutectic (LBE).

14. The energy production device of claim 11, wherein the energy harnessing module comprises at least two energy harnessing modules.

15. The energy production device of claim 14, wherein the control system is configured to control energy production of the energy production device by staging the at least two energy harnessing modules.

16. The energy production device of claim 14, wherein the at least two energy harnessing modules comprise different types of energy harnessing modules.

17. The energy production device of claim 14, wherein the at least two energy harnessing modules comprise at least one of a Stirling engine and a heat exchanger.

18. The energy production device of claim 11, wherein the core further comprises an inert gas over the heat transmission fluid.

19. A method of harnessing nuclear energy comprising:
controlling a nuclear fission reaction in a core including fuel rods;
heating heat transmission fluid with the controlled nuclear fission reaction to cause a heat transmission fluid to flow upwards through the core through natural convection;
cooling the heat transmission fluid by transferring heat to an energy harnessing device through a heat exchanger positioned over the core;
harnessing the heat from the heat exchanger for storage, transmission, or conversion into another form of energy with the energy harnessing device;
flowing the heat transmission fluid through a downtube separate from the fuel rods after cooling the heat transmission fluid; and
re-introducing the cooled heat transmission fluid below the fuel rods.

20. The method of claim 19, wherein cooling the heat transmission fluid by transferring heat to the energy harnessing device further comprises:
cooling the heat transmission fluid by transferring heat to an intermediate fluid in the heat exchanger; and
transferring the heat from the intermediate fluid to the energy harnessing device through the heat exchanger.
